(19) United States
(12) Patent Application Publication
(10) Pub. No.: US 2013/0118889 A1
(43) Pub. Date: May 16, 2013

(54) METHOD AND APPARATUS FOR SALT PRODUCTION

(71) Applicant: Peter Johnstone, Humevale (AU)

(72) Inventor: Peter Johnstone, Humevale (AU)

(73) Assignee: FIRST GREEN PARK PTY LTD, Humevale, Victoria (AU)

(21) Appl. No.: 13/640,242

(22) PCT Filed: Apr. 7, 2011
(86) PCT No.: PCT/AU2011/000394

§ 371 Date: Jan. 15, 2013

(30) Foreign Application Priority Data
Apr. 7, 2010 (AU) 2010901455

(51) Int. Cl. B01D 1/00

(52) U.S. Cl. CPC B01D 1/0035
USPC 203/12; 202/234

(57) ABSTRACT

A method of producing one or more precipitable substances such as salt (NaCl) from a feed liquid source (such as sea water) in a precipitation apparatus, the method involving steps of providing a first solar energy treatment arrangement having at least one treatment panel construction having an upper solar energy transmission wall capable of passing solar energy to a treatment member located beneath the upper solar energy transmission wall, the or each treatment panel construction being arranged to receive liquid from the feed liquid source, the solar radiation energy concentrating the precipitable substance or substances in the treatment liquid within the or each said treatment panel construction, the method further sensing via a sensor the density of the treatment liquid discharged from the first solar energy treatment arrangement, returning the liquid discharged from the first solar energy treatment apparatus to an inlet region of the first solar energy treatment apparatus if the sensed density is below a first predetermined density level, passing liquid discharged from said first solar energy treatment arrangement to a final solar energy treatment arrangement having at least one final treatment panel construction having an upper solar energy transmission wall capable of passing solar energy radiation to a treatment member, distributing treatment liquid across a surface region of the treatment member whereby a precipitable substance is precipitated onto the surface region and subsequently removing the precipitable substance.

### PRIORITY CLAIM

The present application is a National Phase entry of PCT Application No. PCT/AU2011/000394, filed Apr. 7, 2011, which claims priority from Australian Patent Application No. 2010901455, filed Apr. 7, 2010, the disclosures of which are hereby incorporated by reference herein in their entirety.

### FIELD OF THE INVENTION

The present invention relates to methods and apparatus for producing minerals or other precipitable substances including salt by precipitation from a water source by the application of solar radiation. The water source might be sea water when the intention is to product salt.

### BACKGROUND OF THE INVENTION

It is known to introduce sea or saline water into a shallow bed subject to solar radiation over a period of time during which the water is evaporated off leaving crystalline salt (NaCl) that can be collected and used as required. Such arrangements are well known but are subject to introduction of impurities from the environment and from the production techniques. The objective of the present invention is to provide an improved method of producing conventional salt (NaCl), and other salts or precipitable substances from a liquid source including sea water, ground water and industrial or other commercial water sources including waste water that might otherwise be discharged into the environment. A particularly preferred objective of this invention is to provide a method as aforesaid with substantially no waste water or liquid discharge. A further objective is to provide improved apparatus for use in the aforesaid methods.

### SUMMARY OF THE INVENTION

According to a first aspect of this invention there is provided a method of producing a precipitable substance from a feed liquid source, the method including the steps of:
(i) providing a treatment panel construction having an upper solar energy transmission wall capable of passing solar radiation to a treatment member located beneath the upper solar energy transmission wall;
(ii) supplying liquid from feed liquid source to one region of the treatment member and distributing the liquid across a surface region of the treatment member to be subject to solar radiation passed through the upper solar energy transmission wall;
(iii) evaporating water from the liquid distributed on the surface region to precipitate the precipitable substance from the liquid by the application of solar radiation; and
(iv) removing the precipitable substance from the treatment member.

Other features of the above method may be as defined in claims 2, 3, 4 and 5 as annexed hereto, the subject matter of these claims being included in the disclosure of this specification by this reference thereto.

In accordance with a further aspect of the present invention there is provided a method of producing one or more precipitable substances from a feed liquid source in precipitation apparatus, the method including the steps of:
(i) providing a first solar energy treatment stage arranged to receive liquid from the feed liquid source, the first solar energy stage having at least one first solar energy treatment arrangement having at least one treatment panel construction having an upper solar energy transmission wall capable of passing solar radiation to a treatment member located beneath the upper solar energy transmission wall, the solar radiation concentrating the precipitable substance or substances in liquid within the or each treatment panel construction;
(ii) determining the density of the liquid discharged from the or each first solar energy treatment arrangement;
(iii) returning the liquid discharged from the or each first solar energy treatment arrangement to or within the first solar energy treatment stage if the determined density of the liquid discharged from a first solar energy treatment arrangement is below a first predetermined density level;
(iv) passing liquid discharged from the first solar energy treatment stage to a final solar energy treatment arrangement having at least one final treatment panel construction having an upper solar energy treatment wall capable of passing solar energy radiation to a treatment member located beneath the upper solar energy transmission wall, distributing the liquid across a surface region of the or each treatment member to be subject to solar radiation passed into the or each final treatment panel construction whereby a precipitable substance is precipitated onto the surface region of the or each treatment member; and
(v) removing the precipitable substance from the or each treatment member.

Conveniently, solar radiation levels directed to the first solar energy treatment arrangement are sensed and at least the volume of the liquid from the feed liquid source is adjusted in response to sensed radiation levels. Flow volumes of the treatment liquid may also be adjusted in response to any one or more of sensed atmospheric conditions including temperature, humidity or wind levels.

Preferably a flow volume rate of the liquid delivered to the or each first treatment arrangement is measured, the or each first treatment arrangement also producing a clean water condensate flow with the flow volume rate of the clean water condensate from the or each first treatment arrangement also being measured, the density of the liquid discharged from the or each treatment panel being determined from the measure of flow volume rates.

In an embodiment, the above described method may include at least two solar energy treatment arrangements in the first solar energy treatment stage, the or each first solar energy treatment arrangement being arranged to receive the liquid discharged from either feed liquid source or a preceding first solar energy treatment arrangement in the first solar energy treatment stage, the solar radiation passing through the upper solar energy transmission wall of the or each treatment panel construction of the or each first solar energy treatment arrangement further concentrating the precipitable substance or substances in the liquid within the or each treatment panel construction.

Conveniently, the density level of the liquid discharged from the or each first solar energy treatment arrangement is sensed, and if the sensed density level is less than a desired predetermined level, the discharged liquid is returned to an inlet region of the or a preceding first solar energy treatment arrangement.

In an arrangement, at least a proportion of the liquid discharged from a first solar energy treatment arrangement is collected to separately precipitate a precipitable substance therefrom, any liquid remaining from the separate precipitation being returned to the first solar energy treatment stage or to the final solar energy treatment arrangement. Conveniently, any liquid remaining from separate precipitation of the precipitable substance is returned to the precipitation apparatus utilized in the aforesaid method, for further processing.

In an arrangement, in one or more of the first or further solar energy treatment arrangements includes structure to condense water evaporated from the liquid and to collect the condensed water as a clean water discharge.

The feed liquid source may be any source containing dissolved substances capable of being precipitated therefrom including but not limited to sea or other saline water, ground water, and contaminated water from industrial or other commercial processes. The precipitable substances include, but are not limited to salt (NaCl), MgCl₂, sodium bicarbonate, gypsum, minerals, and metals.

Preferably, the method provides zero waste liquid discharge, i.e. the liquid is consumed in the final solar energy treatment arrangement. If any liquid remains, it is collected and either returned or further separately processed to recover useful substances therefrom.

In accordance with a further aspect, the present invention also provides a panel construction for the production of a precipitable substance or substances from a feed liquid source, the panel construction including:
(i) an upper solar energy transmission wall that is substantially clear or highly translucent for passing solar energy therethrough;
(ii) a treatment member positioned beneath the upper wall having a surface region that in use is impacted by the solar energy passing through the upper wall;
(iii) a treatment liquid delivery means for delivering the treatment liquid from the feed liquid source to the surface region and distributing the treatment liquid across the surface region, the delivery means delivering the treatment liquid at a flow rate of between 0.2 and 10 litres/square meter of the surface region of the treatment member/hour; and
(iv) support means for the panel construction whereby, in use, the panel construction has an angle of inclination between about 0° and 5° to the horizontal.

Conveniently, the panel construction includes flow control apparatus to control the flow of the treatment liquid to the surface region. Conveniently, the treatment liquid flow rate is arranged to flow at an average flow rate of about 3 litres/square meter/hour. Preferably the control means is adjusted in response to solar sensed solar radiation levels impinging on the upper solar energy transmission wall, that is the flow rate of the treatment liquid is increased if the sensed solar radiation levels is relatively higher. In an embodiment the density of any treatment liquid discharged from the panel construction is tested and if below a predetermined level, the discharged treatment liquid is returned to an inlet flow to the panel construction.

In an embodiment, the upper solar energy transmission wall is removable from the treatment member. The upper solar energy transmission wall might include fixing means to enable the wall to be operationally fixed to the treatment member, but removed when desired. Conveniently, air flow means is provided to allow air flow through the panel construction. Preferably air flow is arranged to flow in the direction of flow of the treatment liquid over the treatment member. Conveniently, any air flow openings associated with the air flow means include coverings providing no or only limited restrictions to air flow but preventing ingress of other unwanted contaminants.

Conveniently, the treatment member is a tray, the surface region is an upwardly facing surface of a base wall of the tray, and the treatment liquid is retained on the surface region by upstanding perimeter walls along at least side edge regions of the base wall of the tray. Preferably the tray is formed from a metal foil or plastics material. Conveniently, a porous layer may be positioned on the base wall of the tray. The tray may include transversely extending corrugations located between side edge regions of the base wall.

Several embodiments of the present invention may be as disclosed in the annexed drawings and further described with reference thereto hereinafter.

### BRIEF DESCRIPTION OF THE DRAWINGS

FIG. 1 is a schematic flow diagram of a form of precipitation apparatus according to the present invention;

FIG. 2 is a schematic perspective view of a panel construction according to the present invention, the internal structure of which may be in accordance with any of the embodiments described herein including those represented in FIGS. 3 to 7 inclusive;

FIG. 3 is a section view through line II-II of FIG. 1;

FIG. 4 is a section view through line III-III of FIG. 2;

FIG. 5 is a section view through line III-III of an alternative embodiment similar to FIG. 2;

FIG. 6 is a section view along line V-V of FIG. 2 showing a still further possible embodiment;

FIG. 7 is a section view of the embodiment shown in FIG. 6 taken along line II-II of FIG. 1;

FIG. 8 is a schematic perspective view of a tray member usable in a panel construction according to a further embodiment; and

FIG. 9 is a cross-sectional view along line XI-XI of FIG. 8 showing the panel construction including the upper solar energy transmission wall.

### DETAILED DESCRIPTION

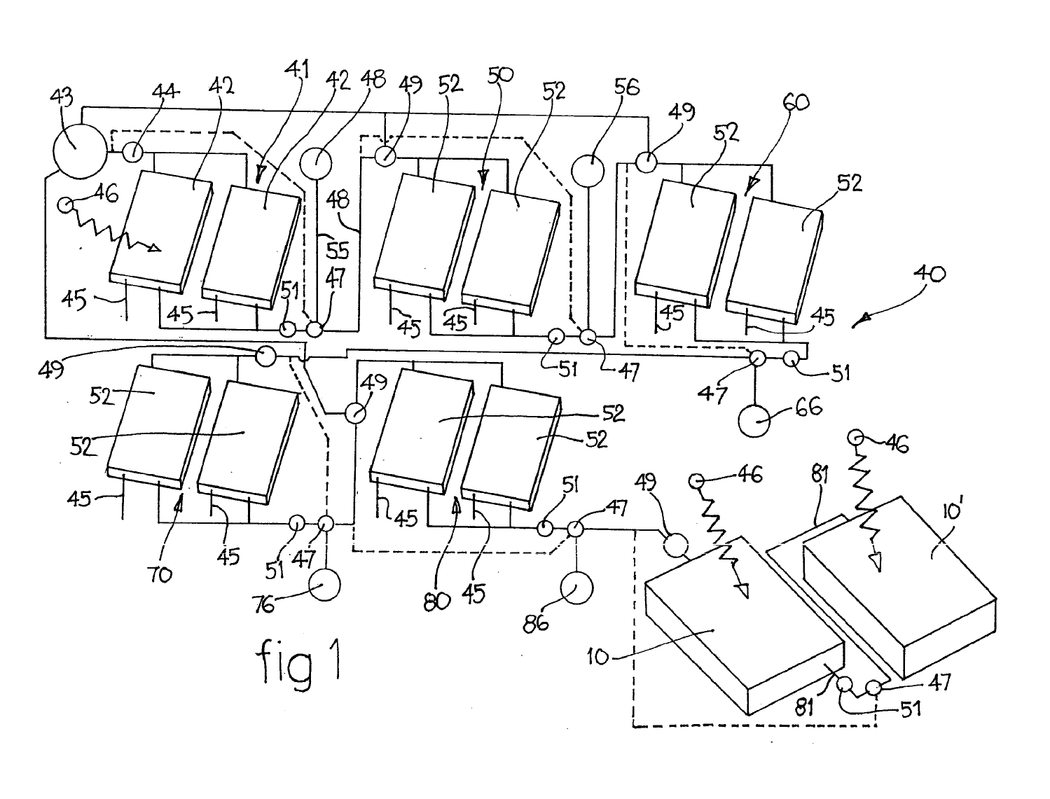

Referring to FIG. 1, one possible precipitation apparatus 40 is illustrated in a schematic block diagram. The apparatus 40 comprises a first solar energy treatment arrangement 41 including at least one treatment panel construction 42. In the illustrated embodiment, two panel constructions 42 are shown but multiple such panel constructions could be provided. Each treatment panel construction 42 might be constructed as described in International Patent Application Nos. PCT/AU2009/000503 and PCT/AU2010/001533, the disclosures of these applications incorporated herein by reference. The panel constructions 42 receive treatment liquid from a feed liquid source 43, preferably via a flow control device 44. The treatment liquid is partly evaporated in the treatment panel construction or constructions 42 with the evaporated water being condensed, collected as clean water and discharged at 45. The clean water discharge 45 from all treatment panel construction or constructions 42 or other similar such constructions as described hereafter can be commonly collected and used as may be desired. In an alternative arrangement a volume flow rate of the treatment liquid flowing to the panel constructions 42 might be measured. The volume flow rates of the clean water condensate flowing along lines 45 from the panel constructions 42 might also be measured and these measurements might be used to measure the density of the liquid discharge at 47 to control the valve means 47 by this measured density valve.

Conveniently, a solar energy sensor 46 might be provided to sense the level of solar energy radiation impinging on the panel constructions 42, the sensed level being used to control the flow control device 44. The treatment liquid discharged from the panel constructions 42 are collected and tested for density levels via a sensor 51 to ensure that the density level has reached a first predetermined level. If it is below the first predetermined level, it is recycled by being returned via a valve means 47 to a position upstream of the flow control device 44. If desired a proportion of the treatment liquid discharged that is at or above the first predetermined level might be diverted via the valve means 47 to a separate process unit 48 to recover solids content in the concentrated liquid.

The treatment liquid discharged from the first solar energy treatment arrangement 41 may be delivered via line 48 and a flow control device 49 to a further solar energy treatment arrangement 50. Again the arrangement 50 may be comprised of at least one but possibly multiple further treatment panel constructions 52 which again can be manufactured as described in International Patent Application Nos. PCT/AU2009/000503 and PCT/AU2010/001533. Again a sensor 51 senses density levels of the liquid discharged from the panel construction or constructions 52 and the sensor 51 controls the valve means 47 to either return treatment liquid to an inlet zone of the further first solar energy treatment arrangement 50 or to pass the treatment liquid on to a further alternative treatment stage 48 via line 55 if the density level is at or above a predetermined level. Further treatment stages 60, 70, 80 may be provided where like features in the further first solar energy treatment arrangement 50 have been given the same reference numerals. At each stage 50, 60, 70 or 80, it is possible, but not essential, that the treatment liquid might be diverted to a separate treatment process 56, 66, 76 or 86 to recover any desirable substances in the concentrated treatment liquid. Instead of sensors 51, the volume flow rate of treatment liquid delivered and the volume flow rate of clean water condensate exiting via lines 45 might be used to determine liquid density at each of the valve means 47.

While FIG. 1 schematically represents each stage 41, 50, 60, 70 and 80 as having two treatment panel constructions 42, 52, as the volume of treatment liquid is progressively decreasing as it passes through the apparatus 40, the number of panel constructions 42, 52 required in progressive stages should also decrease.

Treatment liquid leaving the final further stage 80 via line 81 passes, preferably via a flow control device 49 to a treatment panel construction 10 (as described hereafter) or a pair of such panel constructions 10, 10′. While two such panel constructions 10, 10′ are illustrated further such panel constructions 10 (or 10′) could be employed. If the apparatus 40 is intended to process sea water as the feed liquid source 43, the first panel 10 is adapted to precipitate salt (NaCl) when the treatment liquid has a concentration level of 1.18 to 1.25 with any remaining treatment liquid being transferred to a subsequent panel construction 10 or ultimately to a panel construction 10′ for MgCl₂ to be recovered from liquid at a concentration level of about 1.35. If desired and if there is any remaining treatment liquid it might simply be collected and processed separately. Conveniently again the discharged liquid density level may be tested at 51 and returned for reprocessing if the concentration is below the level required to precipitate NaCl, in the potential example given. Again solar energy radiation sensors 46 might also be employed to control entry flow rates via control devices 49 to maintain the density of the liquid passing into the panel construction 10, 10′ at the required level to precipitate the required substance (typically NaCl with sea water as the feed liquid). Liquid density levels at 51 might alternatively be measured by measuring liquid volume flow rates in (for example) at 49, and out (for example) at 51. Treatment liquid may be pumped, if required around the apparatus 40 but preferably gravitational flows are desirable to minimize power consumption. Conveniently, at each stage 50, 60, 70 or 80 discharged treatment liquid might be diverted for separate treatment in suitable devices 56, 66, 76 or 86 to recover desirable substances in the liquid.

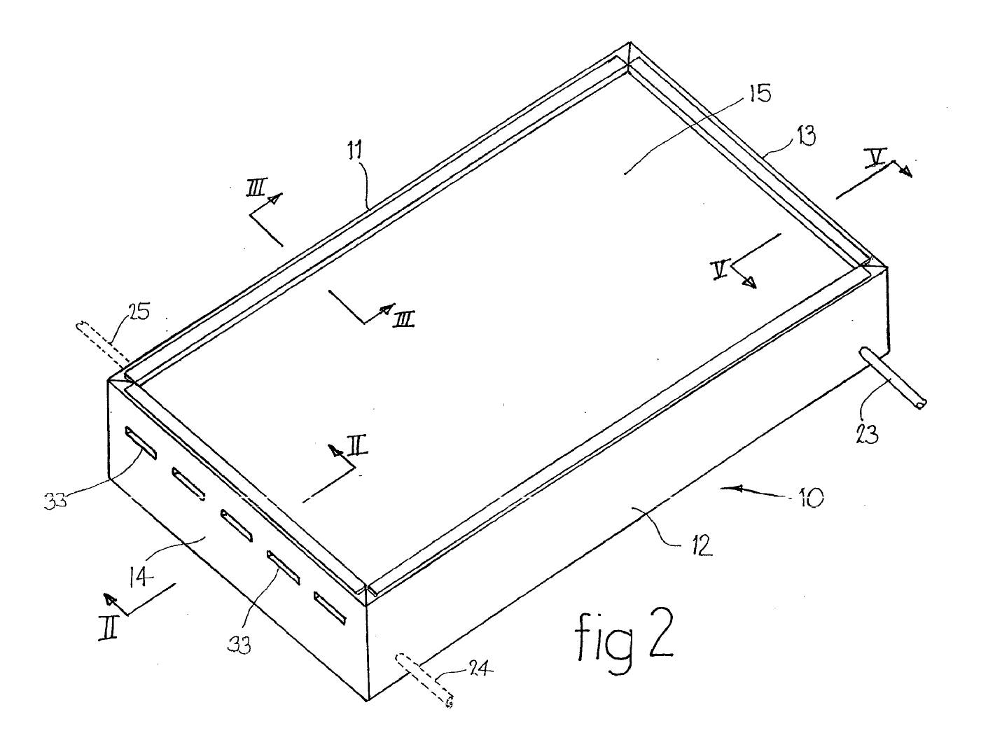

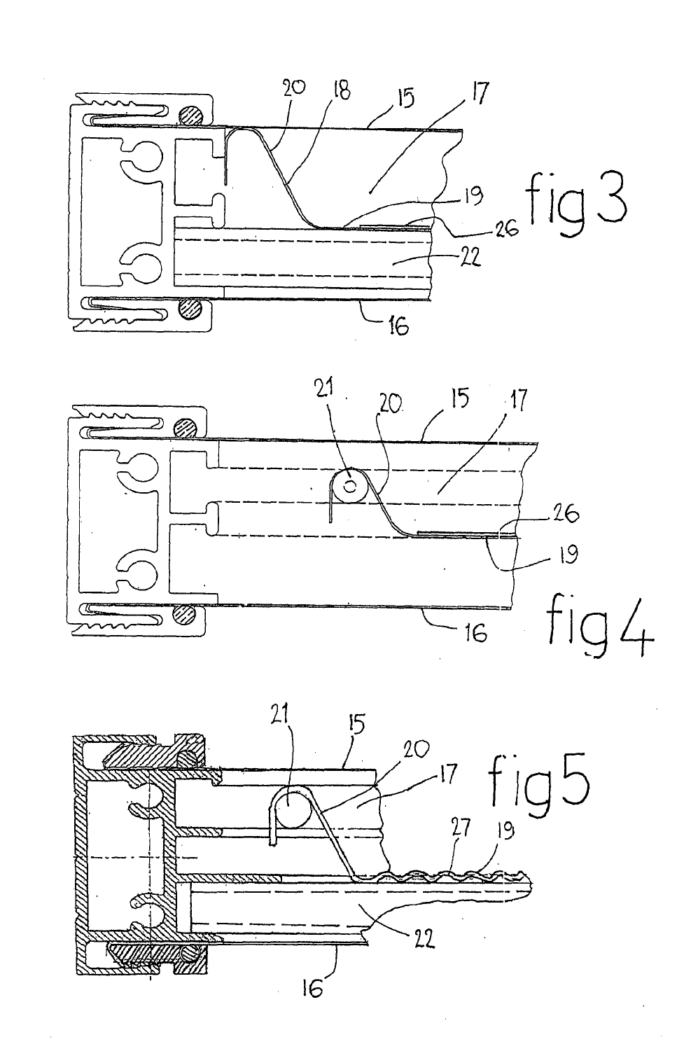

Referring to FIGS. 2 to 7 of the drawings, a treatment panel construction 10 is illustrated. The panel construction 10 is formed by side edge members 11, 12 and end edge members 13, 14 in a rectangular configuration with an upper wall 15 formed by a sheet of flexible plastics material and a lower wall 16 formed by a sheet of flexible plastics material to define an interior treatment chamber 17. The general construction of at least the outer extremities of the panel construction 10 may be as disclosed in International Patent Application No. PCT/AU2010/001533. The subject matter of this specification is included in the present specification by this cross reference thereto for a proper understanding of the present invention. Within the treatment chamber 17, a tray 18 may be supported, preferably spaced from the upper wall 15 that is substantially clear or highly translucent to allow solar energy to pass therethrough. The tray 18 has a base wall 19 and upstanding perimeter walls 20 at least on its side edges. The side edge perimeter walls 20 may include upper and lower end walls but in one embodiment, the lower upstanding end wall might be omitted. The tray 18 might be supported by cross bar members 21 and at least one longitudinally extending member 22 or in an alternative arrangement, the tray 18 might simply engage and be supported on the base wall 16 of the treatment chamber 17. In this embodiment, the base wall 16 might be made of a solid self supporting structural material. The tray 18 might be formed from a suitable gauge metal foil including aluminium or aluminium alloys or be made from a molded plastics material. Other materials/metals could also be used although it would be preferable to employ materials that would be resistant to degradation from the liquid supplied thereto, e.g. sea water or saline water. In one embodiment a tray member formed from plastics film might be employed.

In use, the panel construction 10 is suitably supported in the open with the upper wall 15 facing upwardly and subject to available solar energy radiation. The panel construction may be supported with a low angle of inclination, i.e. 0° to 5°. Sea or saline water or concentrated such water via apparatus shown in FIG. 1 may be supplied by a delivery tube or pipe 23 to one or an upper end of the tray 18 so that it flows downwardly on or be distributed across the tray base wall 19. The angle of inclination is low or non existent so the flow rate of water across the tray base wall 19 is within an average flow rate range of 1 to 10 liters/square meter of the area of the tray base wall 19/hour, preferably around about 3 liters/square meter/hour to establish maximum engagement with solar radiation energy entering the chamber 17. Of course when the atmospheric conditions are colder/cloudier the flow rate will be relatively less than if the weather is hotter/sunnier the flow rate will be relatively greater. The water is evaporated and either allowed to escape the chamber 17 or condenses on the inner surface of the upper wall 15 to be collected and discharged via line 24. Any treatment water reaching the other end of the tray base wall 19 might be discharged via an overflow discharge line 25 but conveniently, the flow rate of the treatment water is such that there is minimal build up of same at the other or linear end of the tray base wall 19. It is of course possible to direct any such water back to the inflow or delivery pipe 23 of the panel construction or to a similar panel construction to thereby ensure ultimately there is no discharge of such liquid to the environment.

The upper surface of the tray base wall 19 may have a hydrophilic surface (to the treatment liquid) to promote an even distributed film flow over the surface. Further, the construction may include a removable porous layer 26 covering substantially all of the surface. The salt formed on the production method of this invention may build up on the layer 26 and when sufficient salt has been formed, the layer 26 and the salt carried thereby can be removed by removing the upper wall 15. Thereafter the salt can be stripped from the layer 26 and the layer 26 can either be reused if it remains suitable for the task or it can be replaced with a new such layer. In a possible alternative the base wall 19 of the tray may include low profile ripple or corrugations 27 extending transversely across the tray 18. In this case, the salt builds directly on the base wall 19 and the tray 18 itself needs to be removed from the chamber 17 when the salt is to be stripped therefrom.

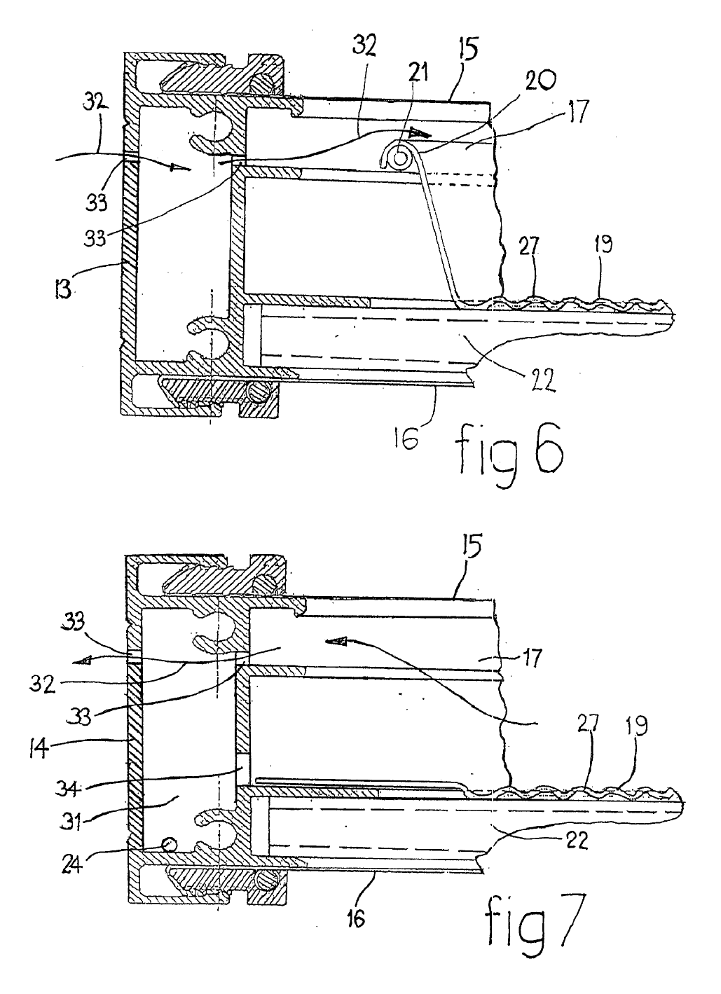

In a preferred arrangement (FIGS. 6/7), the lower end 30 of the tray base wall 19 may have no upright end wall permitting any excess treatment water to flow into a cavity 31 through an opening 34 in the end wall 14 to be discharged via line 24 and recycled as discussed earlier. It is preferred that air flow 32 be allowed to flow over the tray 18 between the two ends 13, 14 through suitable openings 33 formed therein. Conveniently, the depth of the tray 18 is reasonably high, about 200 to 600 mm, so that a reasonable quantity of salt can be formed before it is required to remove same from the panel construction 10. The panel construction might have a length of about two meters and a width of about one meter.

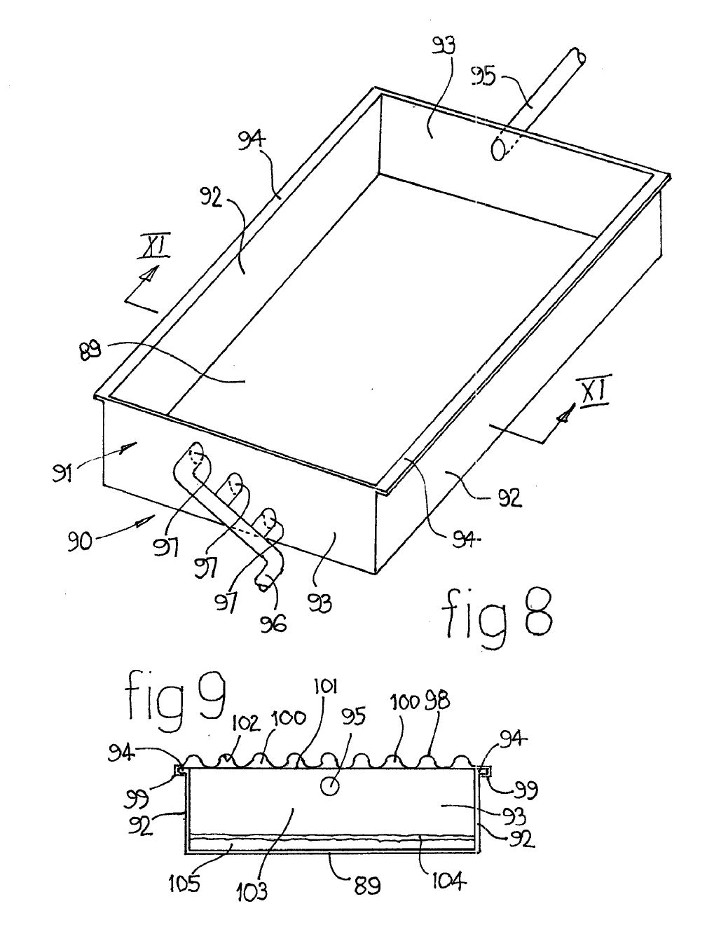

FIGS. 8 and 9 illustrate a further simplified treatment panel construction 90 comprising a tray 91 with a base wall 89 and peripheral side walls 92 and end walls 93. A side ledge 94 extends along the upper edges of the side walls 92. An inlet pipe 95 allows treatment liquid 104 to be introduced onto the upper surface of the base wall 92 and a discharge pipe 96 allows treatment liquid 104 not consumed in the panel construction 90 to be either recycled or transferred to a subsequent treatment panel construction 10′. Ultimately it is preferred that no treatment liquid be discharged from the apparatus. The discharge pipe 96 might include inlets 97 at varying heights to allow for precipitate 105 build up on the base wall 92. The top wall 98 may be a clear rigid plastic sheet to allow solar energy to pass therethrough. The top wall 98 may be corrugated with edge clip means or similar 99 enabling the wall 98 to be connected to the side wall ledges 94. The gaps 100 at the ends of the top wall 98 between the top edge 101 of the end walls 93 and the under surface 102 of the top wall 98 may be covered by a mesh or similar material allowing air flow therethrough and through the zone 103 within the tray 91. The mesh covering allows desirable air flow while preventing ingress of contaminant materials. Further modifications and improvements may be made within the scope of the annexed patent claims.

1. A method of producing a precipitable substance from a feed liquid source, said method including the steps of:
(i) providing a treatment panel construction having an upper solar energy transmission wall capable of passing solar radiation to a treatment member located beneath said upper solar energy transmission wall;
(ii) supplying liquid from said feed liquid source to one region of said treatment member and distributing said liquid across a surface region of said treatment member to be subject to solar radiation passed through said upper solar energy transmission wall;
(iii) evaporating water from the liquid distributed on said surface region to precipitate said precipitable substance from said liquid by the application of solar radiation; and
(iv) removing the precipitable substance from said treatment member.

2. A method according to claim 1 wherein the treatment member or at least a part of the treatment member is removed from said panel construction before accumulated precipitated substance is removed therefrom.

3. A method according to claim 1 wherein the feed liquid source originates from a preceding process stage wherein solids contents in the liquid have been concentrated to a predetermined known concentration level.

4. A method according to claim 1 wherein the evaporated water from the liquid distributed on the surface region in step (iii) is released to atmosphere.

5. A method according to claim 4 wherein no said liquid is retained or discharged to the surrounding environment.

6. A method of producing one or more precipitable substances from a feed liquid source in precipitation apparatus, said method including the steps of:
(vi) providing a first solar energy treatment stage arranged to receive liquid from said feed liquid source, said first solar energy stage having at least one first solar energy treatment arrangement having at least one treatment panel construction having an upper solar energy transmission wall capable of passing solar radiation to a treatment member located beneath said upper solar energy transmission wall, said solar radiation concentrating the precipitable substance or substances in said liquid within the or each said treatment panel construction;
(vii) determining the density of the liquid discharged from the or each said first solar energy treatment arrangement;
(viii) returning the liquid discharged from the or each said first solar energy treatment arrangement to or within said first solar energy treatment stage if the determined density of the liquid discharged from a said first solar energy treatment arrangement is below a first predetermined density level;
(ix) passing liquid discharged from said first solar energy treatment stage to a final solar energy treatment arrangement having at least one final treatment panel construction having an upper solar energy treatment wall capable of passing solar energy radiation to a treatment member located beneath said upper solar energy transmission wall, distributing the liquid across a surface region of the or each said treatment member to be subject to solar radiation passed into the or each said final treatment panel construction whereby a precipitable substance is precipitated onto said surface region of the or each said treatment member; and
(x) removing the precipitable substance from the or each said treatment member.

7. A method according to claim 6 wherein solar radiation levels directed to the first solar energy treatment stage is sensed and the volume of said liquid from the feed liquid source is adjusted in response to sensed solar energy radiation levels.

8. A method according to claim 6 wherein a flow volume rate of the liquid delivered to the or each said first treatment arrangement is measured, the or each said first treatment arrangement also producing a clean water condensate flow with the flow volume rate of said clean water condensate from the or each said first treatment arrangement also being measured, the density of the liquid discharged from the or each said treatment panel being determined from said measure of flow volume rates.

9. A method according to claim 6 wherein the method further provides at least two said first solar energy treatment arrangements in said first solar energy treatment stage, the or each said first solar energy treatment arrangement being arranged to receive the liquid discharged from either said feed liquid source or a preceding said first solar energy treatment arrangement in said first solar energy treatment stage, said solar radiation passing through the upper solar energy transmission wall of the or each said treatment panel construction of the or each said first solar energy treatment arrangement further concentrating the precipitable substance or substances in said liquid within the or each said treatment panel construction.

10. A method according to claim 9 wherein the density level of the liquid discharged from the or each said first solar energy treatment arrangement is sensed, and if the sensed density level is less than a desired predetermined level, the discharged liquid is returned to an inlet region of the or a preceding said first solar energy treatment arrangement.

11. A method according to claim 9 wherein at least a proportion of the liquid discharged from a said first solar energy treatment arrangement is collected to separately precipitate a said precipitable substance therefrom, any liquid remaining from said separate precipitation being returned to the first solar energy treatment stage or to said final solar energy treatment arrangement.

12. A method according to claim 9, wherein one or more of said first solar energy treatment arrangements includes means to condense water evaporated from said liquid and to collect said condensed water as a clean water discharge.

13. A method according to claim 6 wherein no waste liquid is discharged from the method.

14. A panel construction for the production of a precipitable substance or substances from a feed liquid source, said panel construction including:
(i) an upper solar energy transmission wall that is substantially clear or highly translucent for passing solar energy therethrough;
(ii) a treatment member positioned beneath said upper wall having a surface region that in use is impacted by said solar energy passing through said upper wall;
(iii) a treatment liquid delivery means for delivering said treatment liquid from said feed liquid source to said surface region and distributing said treatment liquid across said surface region, said delivery means delivering said treatment liquid at a flow rate of between 0.2 and 10 liters/square meter of the surface region of the treatment member/hour; and
(iv) support means for said panel construction whereby, in use, said panel construction has an angle of inclination between 0° and 5° to the horizontal.

15. A panel construction according to claim 14 wherein said upper wall is removable from the panel construction to allow said precipitable substance to be removed therefrom.

16. A panel construction according to claim 14 further including means for returning at least a portion of the treatment liquid from said surface region of the treatment member to the treatment water delivery means.

17. A panel construction according to claim 14 wherein said treatment member is a tray, said surface region is an upwardly facing surface of a base wall of said tray, and said construction includes means for retaining treatment water on said surface region, said means being an upstanding perimeter wall along at least side edge regions of said base wall of said tray.

18. A panel construction according to claim 17 wherein said tray is formed from a metal foil or plastics material.

19. A panel construction according to claim 17 wherein a removable porous layer is positioned on said base wall of said tray.

20. A panel construction according to claim 17 wherein said base wall of said tray includes transversely extending corrugations located between side edge regions of the base wall.
